(19) United States
(12) Patent Application Publication
(10) Pub. No.: US 2010/0026665 A1
(43) Pub. Date: Feb. 4, 2010

(54) Building Block

(75) Inventor: Christoffer Dupont Skovsby, Copenhagen (DK)

Correspondence Address: Mollborn Patents, Inc., 2840 Colby Drive, Boulder, CO, 80305, US

(73) Assignee: DUPONT LIGHTSTONE APS, Copenhagen (DK)

(21) Appl. No.: 12/444,642

(22) PCT Filed: Oct. 26, 2007
(86) PCT No.: PCT/DK2007/000457

§ 371 Date: Jun. 19, 2009

(30) Foreign Application Priority Data
Oct. 27, 2006 (DK) BA 2006 00273

(51) Int. Cl. F21V 8/00; G06F 3/042; H01J 9/24

(52) U.S. Cl. 345/175; 362/559; 445/23; 345/55

(57) ABSTRACT

Methods and apparatus for providing a building block having a number of light transmitting fibers embedded into building materials, such as concrete. The light transmitting fibers have an output end and an input end, where the output ends of the light transmitting fibers are arranged in a display pixel pattern on at least one surface of the building block, and where the input fibers are arranged in an input pixel pattern at an input surface of the building block. A method of manufacturing a building block for the display system is also disclosed.

### CROSS-REFERENCE TO RELATED APPLICATIONS

This application is a National Phase application of PCT application No. PCT/DK2007/000457, entitled “Display System Integrateable into a building structure,” filed on 26 Oct. 2007, which claims priority to Danish Application No. BA200600273, entitled “Display System Integrateable into a building structure,” filed on 27 Oct. 2006.

### BACKGROUND

The present invention relates to a building block. It is very often desired to place large displays, such as advertisements, news, TV, video displays on building surfaces such that the display can be seen by many people. Such large displays are typically constructed as a large electronic TV screen comprising a number of light emitting pixels, such as LCD or LED screens, or constructed by projecting the image onto the surface of the building. The known large scale displays are therefore placed directly on the building surface and when used outside sensitive to various weather conditions, because their electronic circuits for instance can be damaged by rain, snow or wind, and further dust and sand could also damage the displays. It is thus very important to protect these large scale displays against various weather conditions and dust. Another issue is the fact that it is very difficult to integrate the known kind of displays with the building structure in a discreet way such that the display and the building structure would appear as one unit. LED screens are today built into walls but are not considered as a natural part of the building when turned on—and not even when they are turned off. In some applications it is further desired to integrate/place large displays on surfaces such as floors, pavements, roads and other surfaces on floor/street level, but this is not possible with known technologies due to the fact that the existing displays could easily be damaged when positioned on these kinds of surfaces

### SUMMARY

In one aspect, the various embodiments of the invention provides methods and apparatus for providing a building block having a number of light transmitting fibers embedded into building materials, such as concrete. The light transmitting fibers have an output end and an input end, where the output ends of the light transmitting fibers are arranged in a display pixel pattern on at least one surface of the building block, and where the input fibers are arranged in an input pixel pattern at an input surface of the building block.

Various embodiments can include one or more of the following features. The average distance between the pixels of the display pixel pattern can be larger than the average distance between the pixels of the input pixel pattern. The illuminating means can include an optical projector adapted to project the image onto the input pixel pattern. The display system can include at least one photo detector adapted to detect light transmitted from the output end to the input end of at least one of the light transmitting fibers. The display system can include interaction means adapted to register touching of the display pixel pattern based on light detected by the photo detector. The display pixel pattern can be formed as a display matrix pattern that includes a number of pixel positions spread in a number of rows and columns and where only one output end of the light transmitting fibers is positioned in each pixel position.

The input pixel pattern can be formed as an input matrix pattern that includes a number of pixel positions spread in a number of rows and columns and where only one input end of the light transmitting fibers is positioned in each pixel position. The light transmitting fiber can connect an input pixel and an output pixel positioned in similar pixel positions in the input matrix pattern and the display matrix pattern.

In another aspect, the various embodiments of the invention provides methods and apparatus for manufacturing a building block for a display system that can be integrated into the surface of building structures. The building block includes a number of light transmitting fibers embedded into building material, such as concrete. The light transmitting fibers have an output end and an input end, where the output ends of the light transmitting fibers are arranged in a display pixel pattern at one surface of the building block, and where the input ends of the fibers are arranged in an input pixel pattern at a second surface of the building block. The output ends of the light transmitting fibers are be positioned in cells of a display matrix, where the cells of the display matrix approximately form at least a part of the display pixel pattern. The input ends of the light transmitting fibers are positioned in cells of an input matrix, where the cells of the input matrix approximately form at least a part of the input pixel pattern, and where the extent of the input matrix is smaller than the extent of the display matrix. The building block is cast by providing the building material at least partly around the light transmitting fibers.

Various embodiments can include one or more of the following features. The output matrix can include a front plate having a number of holes, where the holes form the cells of the output matrix. The input matrix can include a back plate that has a number of holes, where the holes form the cells of the input matrix. The input matrix and/or the output matrix can be embedded into the surface of the building block by providing the building material around at least a part of the input matrix and/or the output matrix. The input matrix and/or the output matrix can include a string web having a number of strings arranged in a web, where the cells of the input and/or the output matrix are/is separated by the strings. The size of the cells of the input matrix and/or the output matrix can be changed by moving the strings. The input matrix and display matrix can be displaced relative to each other.

### DESCRIPTION OF THE DRAWINGS

In the following, various embodiments of the invention will be described referring to the figures, where

FIGS. 1a and 1b illustrate perspective views of a display system, in accordance with one embodiment of the invention, seen from the front and from behind, respectively;

FIG. 2a illustrates the display system of FIG. 1a and 1b seen from one side, in accordance with one embodiment;

FIG. 2b illustrates a cross section of the building block of FIG. 2a;

FIG. 3a illustrates an embodiment of the display system of FIG. 2b where the display system further includes a photo detector;

FIG. 3b illustrates the display system illustrated in FIG. 3a, in accordance with one embodiment where the photo detector is embodied as a CCD detector;

FIGS. 4a, 4b, 4c and 4d illustrate a method of manufacturing a building block for a display system, in accordance with one embodiment;

FIGS. 5a, 5b, and 5c illustrate another method of manufacturing a building block for a display system, in accordance with one embodiment.

### DETAILED DESCRIPTION

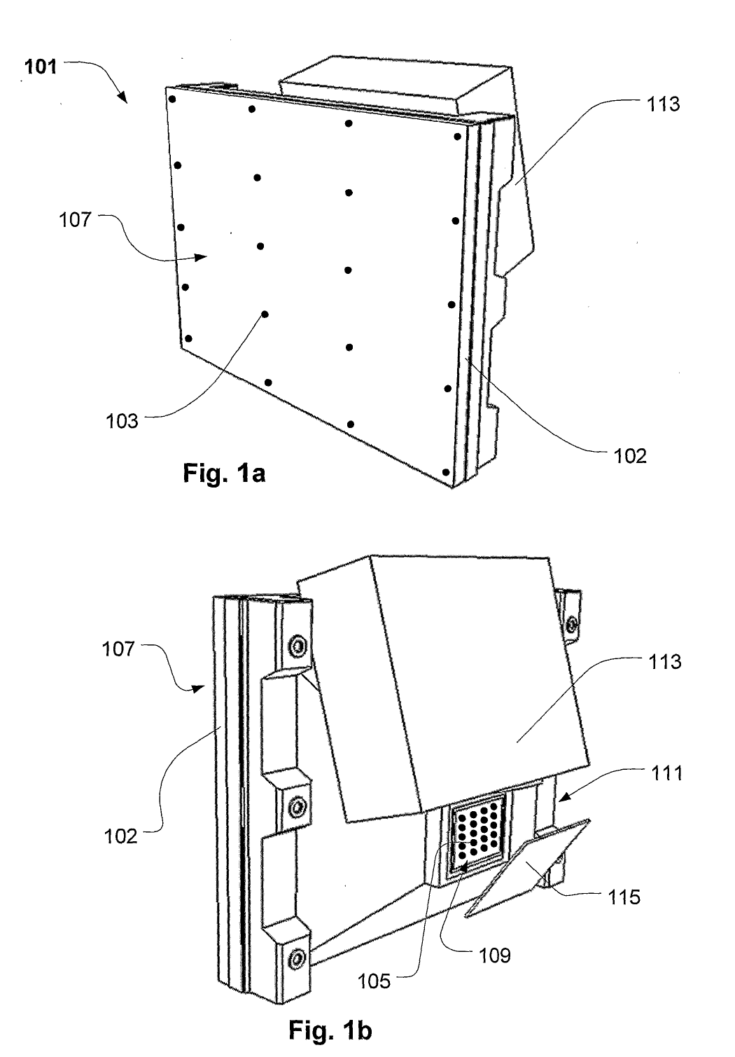

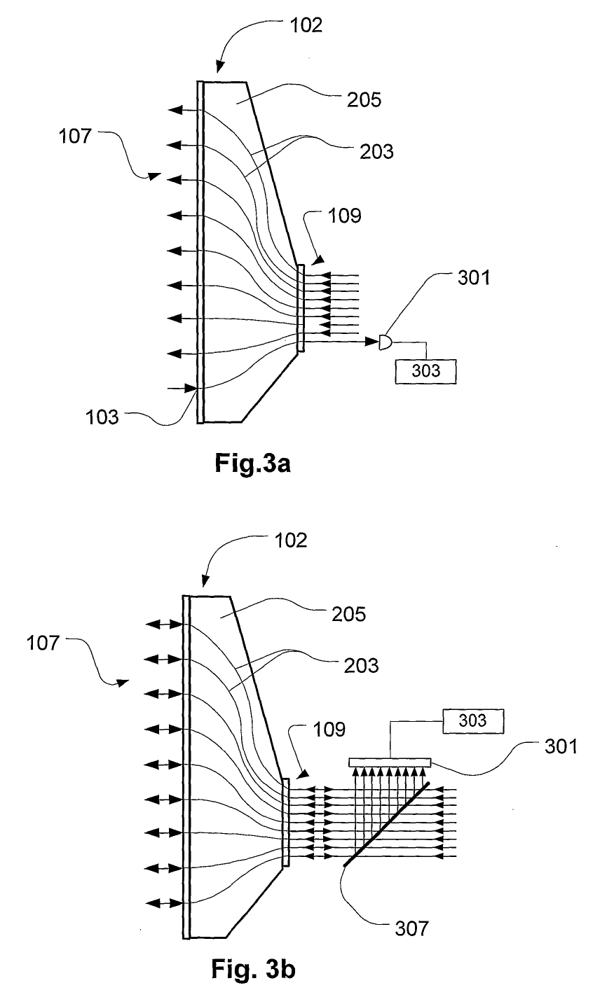

FIGS. 1a and 1b illustrate perspective views of a display system (101) according to one embodiment, where FIG. 1a illustrates the display system seen from the front and FIG. 1b from the behind. The display system (101) includes a building block (102) having a number of light transmitting (see FIG. 3) fibers embedded into building material, such as concrete. The light transmitting fibers have an output end (103) and an input end (105). The output ends of the light transmitting fibers are arranged in a display pixel pattern (107) at one surface of said building block, and the input ends of the light transmitting fibers are arranged in an input pixel pattern (109) at an input surface of the building block. The display system further includes illuminating means (111) adapted to illuminate at least one image onto the input pixel pattern, whereby the image is transmitted to said display pixel pattern through the light transmitting fibers. The illumination means is in the illustrated display system embodied as a video projector (113) where the image is projected and focused onto the input pixel pattern via a mirror (115). The light from the projector enters the input ends of the light transmitting fibers and is thus transmitted to the output end of the fibers. Each light transmitting fiber corresponds to a pixel, and the image would thus be shown at the display pixel pattern of the building block.

For illustration purposes the building block includes in the illustrated embodiment 20 light transmitting fibers, and the input ends (105) are in the input pixel pattern (109) positioned in a 4×5 input matrix pattern comprising 4 rows and 5 columns, and the display pixel pattern is arranged in a similar 4×5 display matrix pattern. The person skilled in the art understands that the resolution of the display system can be improved by increasing the number of light transmitting fibers and that a display system can include thousands of light transmitting fibers positioned in a matrix pattern. The area of the display matrix pattern (107) is larger than the area of the input pixel pattern (109) and the average distance between the pixels is therefore larger at the display pixel pattern than the input pixel pattern. As a result, the image is enlarged at the display pixel pattern compared to at the input pixel pattern. The result is that the input ends are positioned very closely at the input pixel pattern and most of the light illuminated onto the input pixel pattern would be collected by the light transmitting fibers and thus be displayed at the display pixel pattern.

A very bright and intense display which could be integrated into the surface of buildings is hereby provided. The building block is cast in a building material such as concrete and would therefore possess both strength and load capacities and could thus be treated as a bounding element. In the illustrated embodiment the transmitting fiber connects input pixels with the output pixels positioned in similar pixel positions in said input matrix pattern and said display matrix pattern. Hereby it is ensured that the input pixel pattern is mapped correctly at the display pixel pattern and the image would thus be transmitted correctly to the display pixel pattern.

The display system could, in case that the light transmitting fibers do not connect input pixels and output pixels positioned in similar pixel positions, include mapping means adapted to transform the image illuminated at the input pixel pattern in such a way that the resulting image at the display pixel pattern would be displayed correctly. Such mapping means could include computing means connected to the illuminating means and be adapted to move the pixels of the image such that they would illuminate the correct input pixels of the input pixel pattern. The mapping means could in one embodiment include calibration means adapted to calibrate the mapping of the pixels. The calibration means could for instance include means for illuminating the input pixels one at the time and detecting means (e.g. a camera) for detecting to which display pixel the light is transferred, and the calibration means could then be adapted to map the image illuminated onto the input pixels according to the transfer function of the light transmitting fibers.

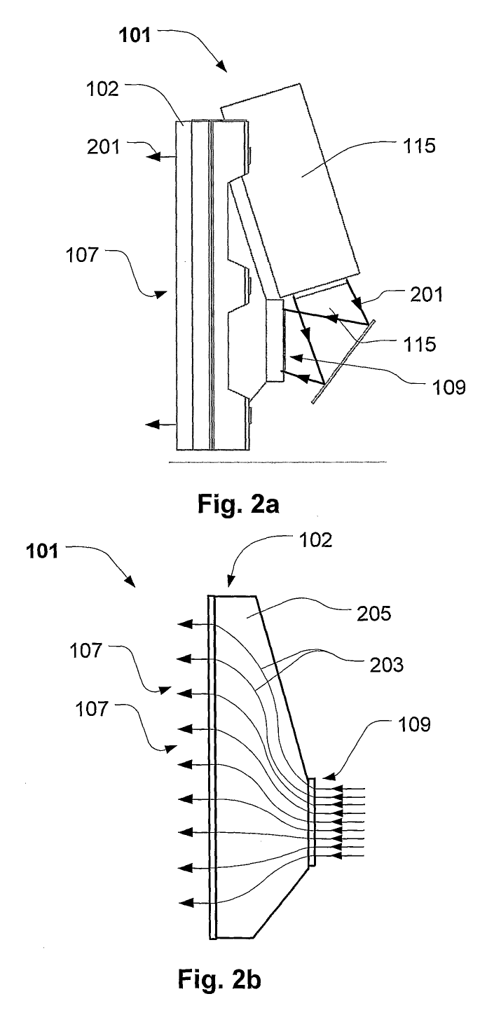

FIG. 2a illustrates the display system of FIGS. 1a and 1b seen from one side, and FIG. 2b illustrates a cross section of the building block (102). The figures illustrate how light (201) is projected by an optical projector onto the input pixel pattern and transmitted through the building block and out of the display pixel pattern. FIG. 2 illustrates a cross sectional view of the building block and illustrates how the light transmitting fibers (203) are embedded into the cast material (205).

In spite of the fact that FIGS. 1 and 2 illustrate that input pixel pattern and output pixel pattern are placed at opposite surfaces of the building block, a person skilled in the art would understand that the input pixel pattern and output pixel pattern could be placed on any surface of the building block because the light transmitting fibers can be bent. The input pixel pattern and display pixel pattern can thus for instance be placed on surfaces perpendicular to each other or even be integrated into the same surface. It is further possible to position both the input pixel pattern and the display pixel pattern on a multiple number of surfaces. The display pixel pattern could for instance be positioned at a corner of a building block, and a part of the display pixel pattern can therefore be seen from one side of the building block and another part from another side of the building block.

FIG. 3a illustrates an embodiment of the display system of FIG. 2b where the display system further includes a photo detector (301) adapted to detect light transmitted from the output end (103) to the input end (105) of at least one light transmitting fiber. The photo detector is connected to interaction means (303) adapted to register touching of the output end of the light transmitting fiber based on light detected by the photo detector. The light interaction means could for instance be embodied in a processor unit capable of receiving a signal from the photo detector and the processor unit is adapted to detect interaction with the display pattern based on the signal from the photo detector. As an example, due to background light around the display pattern, an amount of light would be transmitted from the output end (103) to the input end (105) and be detected by the photo detector. A person can prevent the background light from entering the output end of the light transmitting fiber by touching the output end, and the photo detector will then detect less light and thus send a smaller signal to the interaction means. The interaction means could as a consequence detect the touching of the output. In other embodiments interaction could be based on an increased amount of light instead of a reduction of light.

FIG. 3b illustrates an embodiment of the display system illustrated in FIG. 3a where the photo detector is embodied as a CCD detector (305) with a number of detector pixels corresponding to the number of display pixels. The CCD detector could then detect light transmitted from the output end to the input end of a large number of light transmitting fibers, and the interaction means could then register touching of a large number of output ends. The illustrated embodiment can further include a mirror (307) that reflects light from one side and lets light pass through from one side to the other. It is hereby achieved that the image could be projected on the input pixel (109) pattern from one passing side of the mirror and thereafter be displayed at the display pixel pattern (107). Light transmitted from the display pixel pattern could be reflected onto the CCD detector by the other reflective side of the mirror. It is possible to use the same light transmitting fibers for both transmitting the image and for transmitting light based on which the touching is detected. However, in other embodiments separate light transmitting fibers could be used. It is further possible to have either a larger or smaller amount of light transmitting fibers for the touching detection compared to the number of light transmitting fibers used for displaying the image. The embodiments illustrated in FIGS. 3a and 3b make it possible to make the display system interactive, and a person could then interact with the display system simply by touching the display system. It is therefore possible to integrate an interactive display into a surface of a building structure e.g. a wall or a floor.

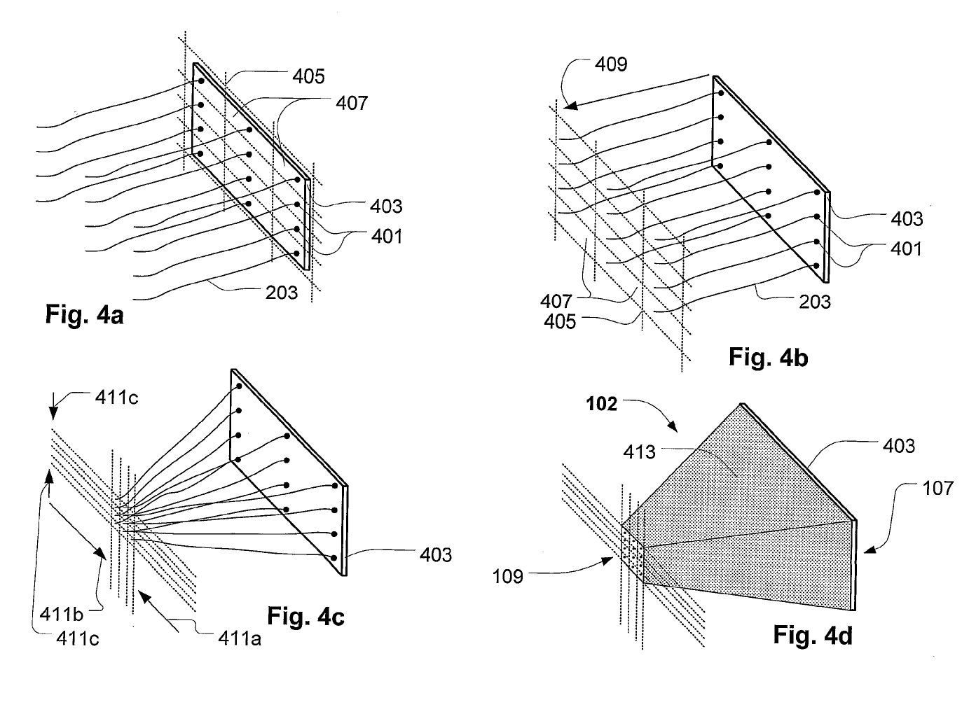

FIGS. 4a, 4b, 4c and 4d illustrate a method of manufacturing a building block for a display system as described above. FIG. 4a illustrates the initial step where the light transmitting fibers (203) are positioned into the cells of a display matrix, where the cells of the display matrix form the display pixel pattern. The display matrix is formed as a front plate (403), e.g. a plate made of steel, plastic, wood etc., having a number of holes (401) which constitute the cells of the display matrix. The light transmitting fibers are thus positioned into the holes (401) of the front plate (403). The light transmitting fibers could be positioned manually or by a robot one at the time, row by row or column by column. An input matrix formed as a string web (405) having a number of strings (illustrated as dotted lines) arranged in a web with a number of cells (407) has, before the fibers are put through the front plate, been positioned adjacent/onto the front plate such that each cell would surround one hole (401). The cells of the string web thus constitute the cells of the input matrix. The light transmitting fibers are, as a consequence hereof, positioned in the cells of the string web when they are positioned in the hole (401) of the front plate (403). FIG. 4b illustrates the next step of the manufacturing method and thus that the string web (405) has been moved away from the front plate as illustrated by arrow (409). The light transmitting fibers (203) are still positioned in the cells of the string web. The size of the cells is changed by moving the strings of the fiber web as illustrated by arrows (411a, 411b, 411c, 411d). The result is that the cells of the string web are smaller and the light transmitting fibers are thus brought closer together and at the same time kept in the same pattern as at the front plate. Building material (413), e.g. concrete, is hereafter as illustrated in FIG. 4d, provided around the light transmitting fibers and a building block is hereby casted. This could for instance be done by providing a mould around the light transmitting fibers such that the bounding block is formed as desired. A building block (102) for a display system as described above is hereby provided and the building block comprises a front plate (403) where the light transmitting fibers are arranged in a display pixel pattern (107) and an input surface where the light transmitting fibers are arranged in an input pixel pattern (109). The strings of the string web could in one embodiment be embedded into the building material and their ends could afterwards be cut off to fit the shape of the building block. However, the string web could in another embodiment not be embedded into the building material and thus be used again when manufacturing another building block. The string web could for instance be mounted in a frame where the strings are mounted in movable joints that can be moved around in the frame. The manufacturing method makes it possible to arrange the light transmitting fibers of a building block to a display system very precisely and at the same time ensure that the pixels of the input pixel pattern and the display pixel pattern are positioned similarly. In another embodiment the manufacturing method comprises the step of positioning the light transmitting fibers in the cells of a second fiber web, and the building block could then be casted between at least two string webs. It is hereby possible to adjust the size of both the input pixel pattern and the display pixel pattern.

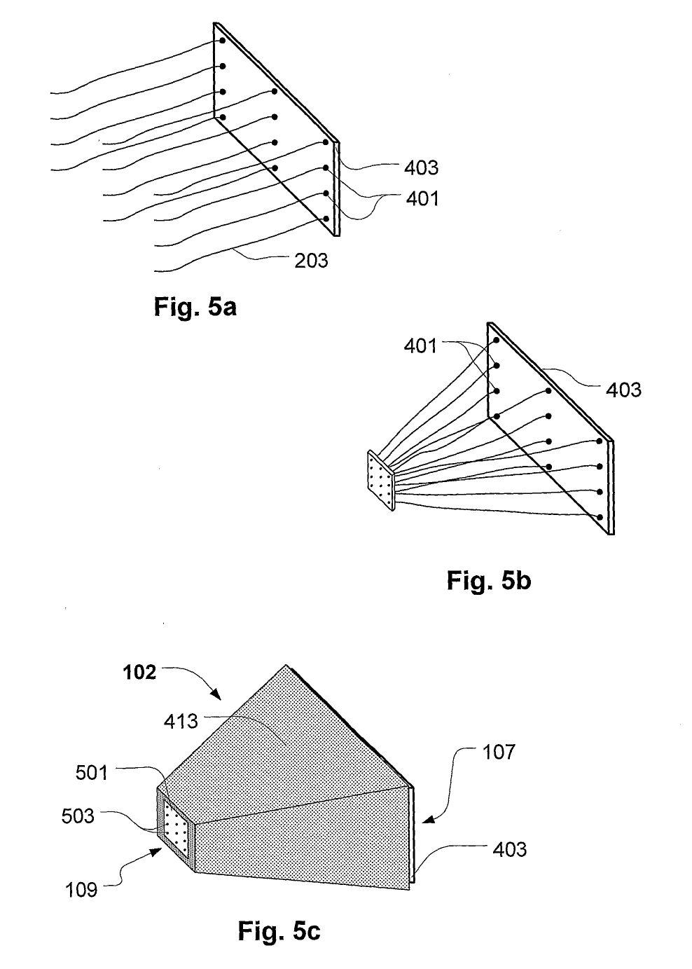

FIGS. 5a, 5b, and 5c illustrate an alternative method of manufacturing a building block for a display system as described above. FIG. 5a illustrates the initial step where the light transmitting fibers (203) are positioned into the cells of a display matrix, where the cells of the display matrix form the display pixel pattern. The display matrix is formed as a front plate (403), e.g. a plate made of steel, plastic, wood etc., having a number of holes (401) which constitute the cells of the display matrix. The light transmitting fibers are thus positioned into the holes (401) of the front plate (403). The light transmitting fibers could be positioned manually or by a robot one at the time, row by row or column by column. FIG. 5b illustrates that the light transmitting fibers are hereafter positioned into the cells of an input matrix, where the cells of the input matrix form the input pixel pattern. The input matrix is formed as a back plate (501), e.g. a plate made of steel, plastic, wood etc., comprising a number of holes (502) which constitute the cells of the input matrix. The light transmitting fibers are thus positioned into the holes (401) of the back plate (403). Building material (413), e.g. concrete, is hereafter, as illustrated in FIG. 5c, provided around the light transmitting fibers and a building block is hereby casted. This could for instance be done by providing a mould around the light transmitting fibers such that the bounding block is formed as desired. A building block (102) for a display system as described above is hereby provided, and the building block comprises a front plate (403) where a part of the front plate has been embedded into the building material and where the light transmitting fibers are arranged in a display pixel pattern (107). The back plate (501) has also been embedded into the building material and comprises an input surface where the light transmitting fibers are arranged in an input pixel pattern (109).

It is to be understood that the illustrated embodiments only serve as illustrating examples rather than limiting the scope of the claims. A person skilled in the art may therefore be able to construct alternative embodiments within the scope of the claims.

1. A building block comprising a number of light transmitting fibers embedded into building material, such as concrete, said light transmitting fibers comprising an output end and an input end, where said output ends of said number of light transmitting fibers are arranged in a display pixel pattern on at least one surface of said building block, and where said input fibers are arranged in an input pixel pattern at an input surface of said building block.

2. The building block of claim 1, wherein the average distance between the pixels of said display pixel pattern is larger than the average distance between the pixels of said input pixel pattern.

3. The building block of claim 1, wherein said illuminating means comprises an optical projector adapted to project said image onto said input pixel pattern.

4. The building block of claim 1, wherein said display system further comprises at least one photo detector adapted to detect light transmitted from the output end to the input end of at least one of said light transmitting fibers.

5. The building block of claim 4, wherein said display system comprises interaction means adapted to register touching of said display pixel pattern based on light detected by said photo detector.

6. The building block of claim 1, wherein said display pixel pattern is formed as a display matrix pattern comprising a number of pixel positions spread in a number of rows and columns and where only one output end of said light transmitting fibers is positioned in each pixel position.

7. The building block of claim 1, wherein said input pixel pattern is formed as an input matrix pattern comprising a number of pixel positions spread in a number of rows and columns and where only one input end of said light transmitting fibers is positioned in each pixel position.

8. The building block of claim 6, wherein said light transmitting fiber connects an input pixel and an output pixel positioned in similar pixel positions in said input matrix pattern and said display matrix pattern.

9. A method of manufacturing a building block for a display system integrateable into the surface of building structures, said building block comprising a number of light transmitting fibers embedded into building material, such as concrete, said light transmitting fibers comprising an output end and an input end, where said output end of said number of light transmitting fibers are arranged in a display pixel pattern at one surface of said building block, and where said input fibers are arranged in an input pixel pattern at a second surface of said building block; said method comprising the steps of:
positioning said output ends of said number of light transmitting fibers in cells of a display matrix, where the cells of said display matrix approximately form at least a part of said display pixel pattern;
positioning said input ends of said number of light transmitting fibers in cells of an input matrix, where the cells of said input matrix approximately form at least a part of said input pixel pattern, and where the extent of said input matrix is smaller than the extent of said display matrix;
casting said building block by providing said building material at least partly around said light transmitting fibers.

10. The method of claim 9, wherein said output matrix comprises a front plate comprising a number of holes, where said holes form the cells of said output matrix.

11. The method of claim 9, wherein said input matrix comprises a back plate comprising a number of holes, where said holes form the cells of said input matrix.

12. The method of claim 9, wherein at least one of said input matrix and said output matrix is embedded into the surface of said building block by providing said building material around at least a part of said input matrix and/or said output matrix.

13. The method of claim 9, wherein at least one of said input matrix and said output matrix comprises a string web comprising a number of strings arranged in a web, where said cells of said input and/or said output matrix are/is separated by said strings.

14. The method of claim 13, wherein said method further comprises the step of:
changing the size of said cells of said input matrix and/or said output matrix by moving said strings.

15. The method of claim 9, wherein said method further comprises the step of:
displacing said input matrix and display matrix relative to each other.
